(19) United States
(12) Patent Application Publication
(10) Pub. No.: US 2009/0296613 A1
(43) Pub. Date: Dec. 3, 2009

(54) METHOD AND APPARATUS FOR PROVIDING QUALITY-OF-SERVICE IN RADIO ACCESS NETWORKS

(76) Inventors: Colin Kahn, Morris Plains, NJ (US); Philip Lamoureux, Succasunna, NJ (US); Maria Palamara, Denville, NJ (US); Mahmoud R. Sherif, Landing, NJ (US); Sherif R. Sherif, Landing, NJ (US); Ahmed A. Tarraf, Bayonne, NJ (US); Mathew Thomas, Madison, NJ (US); Xin Wang, Morris Plains, NJ (US)

Correspondence Address: WALL & TONG, LLP/;ALCATEL-LUCENT USA INC., 595 SHREWSBURY AVENUE, SHREWSBURY, NJ, 07702, US

(21) Appl. No.: 12/132,282

(22) Filed: Jun. 3, 2008

(51) Int. Cl. H04B 7/00

(52) U.S. Cl. 370/310

(57) ABSTRACT

The invention includes a method and apparatus adapted for providing quality-of-service to a packet flow within a Radio Access Network (RAN). In one embodiment, a method includes receiving packets of a packet flow at a first network element of the RAN, where the packet flow is associated with an application normally served in a best effort service class of the RAN and each packet of the packet flow comprises an indication of a quality-of-service policy to be applied to the packet flow within the RAN, and, applying the indicated quality-of-service policy to the packet flow within the RAN. The quality-of-service policy to be applied to the packet flow within the RAN is based on at least one characteristic of the packet flow, which may be determined in any manner, such as using information included in the packet headers, using deep packet inspection techniques, and the like. The indication of the quality-of-service policy to be applied to the packet flow within the RAN may be set either inside the RAN or outside the RAN.

### FIELD OF THE INVENTION

The invention relates to the field of communication networks and, more specifically, to management of quality-of-service in Radio Access Networks (RANs).

### BACKGROUND OF THE INVENTION

In existing Radio Access Networks (RANs), such as Evolution Data Optimized (EV-DO) networks, quality-of-service (QoS) treatment is provided only to QoS-aware applications, not to non-QoS-aware applications. Since many popular applications are non-QoS-aware applications (e.g., Verizon Wireless VCAST, YouTube, Skype, Google-Talk, and the like), packet flows associated with many popular applications currently do not receive QoS treatment within RANs. Disadvantageously, such non-QoS-aware applications must then compete for RAN resource with other applications that are not sensitive to QoS metrics (e.g., File Transfer Protocol (FTP) downloads, e-mail delivery, and the like).

### SUMMARY OF THE INVENTION

Various deficiencies in the prior art are addressed through a method and apparatus adapted for providing quality-of-service to a packet flow within a Radio Access Network (RAN). In one embodiment, a method includes receiving packets of a packet flow at a first network element of the RAN, where the packet flow is associated with an application normally served in a best effort service class of the RAN and each packet of the packet flow comprises an indication of a quality-of-service policy to be applied to the packet flow within the RAN, and, applying the indicated quality-of-service policy to the packet flow within the RAN. The quality-of-service policy to be applied to the packet flow within the RAN is based on at least one characteristic of the packet flow, which may be determined in any manner, such as using information included in the packet headers, using deep packet inspection techniques, and the like. The indication of the quality-of-service policy to be applied to the packet flow within the RAN may be set either inside the RAN or outside the RAN.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a communication network including a radio access network (RAN) and a core network (CN);

FIG. 2 depicts the communication network of FIG. 1 illustrating packet flows associated with the mobile node;

FIG. 3 depicts a high-level block diagram of one embodiment of a method for enabling quality-of-service control for a packet flow within a RAN;

FIG. 4 depicts a high-level block diagram of one embodiment of a method for enabling quality-of-service control for a packet flow within a RAN;

FIG. 5 depicts a high-level block diagram of one embodiment of a method for enabling quality-of-service control for a packet flow within a RAN; and

FIG. 6 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

The present invention enables quality-of-service to be supported in a radio access network. In one embodiment, a quality-of-service policy may be applied to a packet flow associated with a non-QoS-aware application based on one or more characteristics associated with the packet flow. The characteristic(s) associated with the packet flow may be identified inside the RAN, or identified outside of the RAN and signaled to the RAN. The characteristic(s) associated with the packet flow may include one or more of identification of the application associated with the packet flow, endpoint information associated with the packet flow, provider information associated with the packet flow, subscriber/terminal information associated with the subscriber/terminal for which the packet flow is intended, and the like, as well as various combinations thereof.

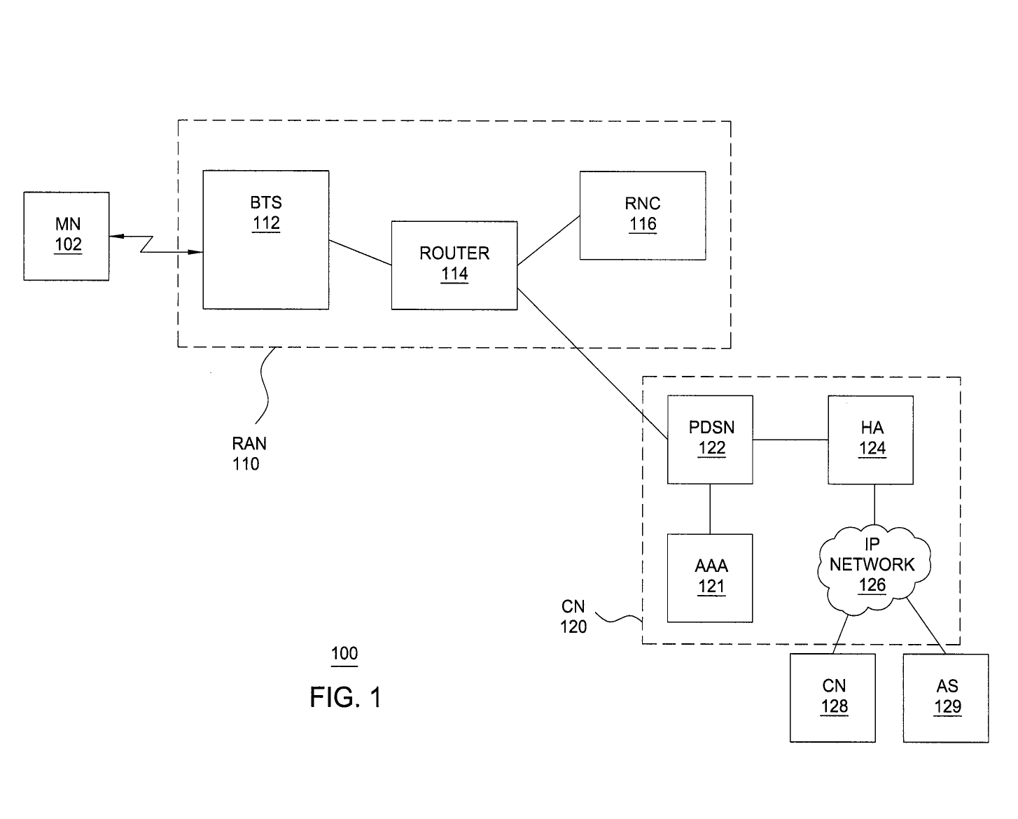

FIG. 1 depicts a high-level block diagram of a communication network. Specifically, the communication network 100 includes a radio access network (RAN) 110 and a core network (CN) 120. The RAN 110 supports communications to/from mobile nodes associated with RAN 110 (illustratively, mobile node (MN) 102). The CN 120 also supports communications to/from mobile nodes associated with the RAN 110, e.g., supporting communications between the mobile nodes and other nodes with which the mobile nodes may communicate (illustratively, correspondent node (CN) 128 and application server (AS) 129 associated with CN 120).

As depicted in FIG. 1, RAN 110 includes a Base Transceiver Station (BTS) 112, a router 114, and a Radio Network Controller (RNC) 116. The MN 102 and BTS 112 communicate wirelessly. The router 114 supports communications between BTS 112 and RNC 116. The router 114 also supports communications between RAN 110 and CN 120. As depicted in FIG. 1, router 114 supports backhaul between RAN 110 and CN 120 via PDSN 122. The RAN 110 may be any type of RAN.

As depicted in FIG. 1, CN 120 includes an Authentication, Authorization, and Accounting (AAA) server 121, a Packet Data Serving Node (PDSN) 122, a Home Agent (HA) 124, and an IP network 126. The IP network 126 provides access to any other nodes available via the Internet (e.g., supporting communications associated with CN 128, AS 129, and the like). The HA 124 supports communications between PDSN 122 and IP network 126. As depicted in FIG. 1, PDSN terminates backhaul between RAN 110 and CN 120 from router 114.

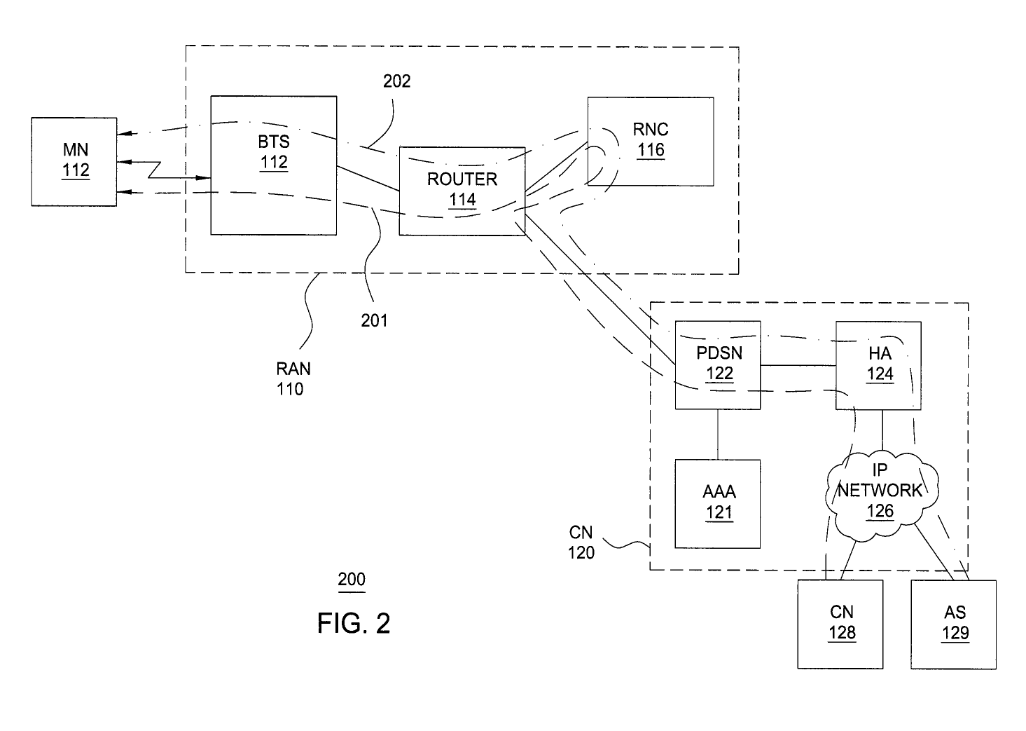

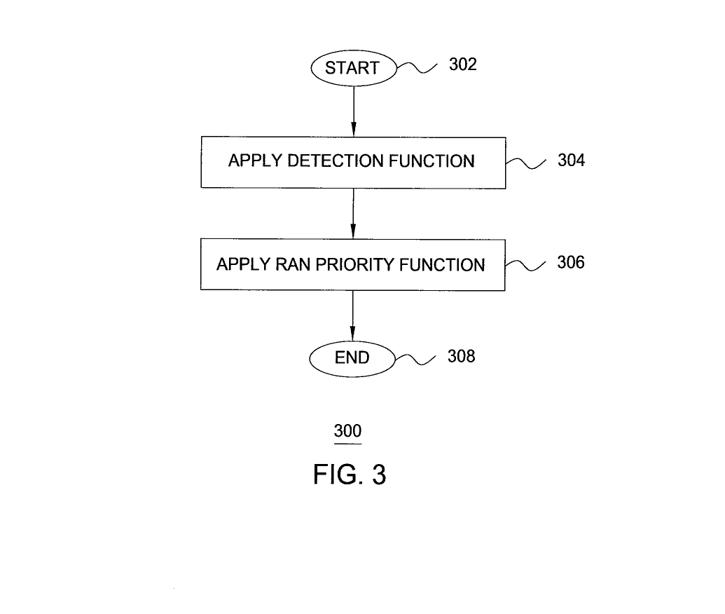

As described herein, communication network 100 supports a Detection Function (DF) and a RAN Priority Function (RPF). The DF determines one or more characteristics of a packet flow of a non-QoS-aware application. The DF may be performed inside RAN 110 (e.g., by router 114) and/or outside RAN 110 (e.g., by one or more of HA 124, PDSN 122, and AAA 121). The RPF applies a quality-of-service policy to the packet flow within RAN 110. The RPF may be performed within RAN 110 by one or both of RNC 116 and BTS 112. The operation of communication network 100 in providing the DF and RPF functions may be better understood with respect to FIG. 2 and FIG. 3.

FIG. 2 depicts the communication network of FIG. 1 illustrating packet flows associated with the mobile node. Specifically, FIG. 2 depicts a first packet flow 201 from CN 128 to MN 102 and a second packet flow 202 from AS 129 to MN 102. For example, first packet flow 201 may an interactive voice session between CN 128 and MN 102 and second packet flow may be a streaming video session between AS 129 and MN 102. In first packet flow 201 and second packet flow 202, packets flow to MN 102 along the following path: IP network 126, HA 124, PDSN 122, router 114, RNC 116, router 114, BTS 112, MN 102.

In one embodiment, quality-of-service control is provided, for a packet flow of a non-QoS-aware application, within RAN 110, based on at least one characteristic associated with the packet flow.

The at least one characteristic associated with the packet flow may include one or more of an identification of the non-QoS-aware application associated with the packet flow, a source of the packet flow, a destination of the packet flow, a provider associated with the packet flow (e.g., a service provider, a network provider, and the like), at least one terminal capability of a terminal associated with the packet flow, at least one attribute of a subscriber associated with the packet flow, and the like.

For example, a determination that a packet flow is originating from a Verizon Wireless VCAST server may result in application of a particular quality-of-service policy to the packet flow. For example, a determination that a packet flow is providing streaming video from YouTube may result in application of a particular quality-of-service policy to the packet flow. For example, a determination that a packet flow is providing packetized voice for an interactive voice session supported by Skype may result in application of a particular quality-of-service policy to the packet flow.

The at least one characteristic which forms the basis for quality-of-service differentiation for different packet flows of non-QoS-aware applications may be based on any other information.

The quality-of-service control is provided for a packet flow within the RAN 110 by determining the at least one characteristic associated with the packet flow and identifying a quality-of-service policy to be applied to the packet flow based on the at least one characteristic associated with the packet flow.

The characteristic(s) associated with a packet flow may be determined in a number of ways, which may vary depending on one or more factors (e.g., the characteristic(s) being determined, the network element(s) determining the characteristic(s), and the like, as well as various combinations thereof).

In one embodiment, in which the characteristic to be determined for a packet flow is the source/destination of the packet flow, the provider associated with the packet flow, or any other similar characteristic, the characteristic may be determined by examining the headers of the respective packets of the packet flow. For example, header examination may be performed by one or more of HA 124, PDSN 122, router 114, and the like.

In one embodiment, in which the characteristic to be determined for a packet flow is an identification of the application of the packet flow or any other similar characteristic, the characteristic may be determined using Deep Packet Inspection (DPI). For example, DPI functions may be performed by one or more of HA 124, PDSN 122, router 114, and the like.

In one embodiment, in which the characteristic to be determined for a packet flow is a terminal capability of a terminal associated with the packet flow, an attribute of a subscriber associated with the packet flow, or any other similar characteristic, the characteristic may be determined using information stored in one or more profiles. For example, profile information may be available from AAA 121 or any other source of such information.

In one embodiment, the characteristic(s) associated with a packet flow is determined outside RAN 110.

In one such embodiment, the characteristic(s) associated with the packet flow is signaled to RAN 110 and the quality-of-service policy to be applied to the packet flow based on the at least one characteristic associated with the packet flow is determined within RAN 110.

In another such embodiment, the characteristic associated with the packet flow is used to determine the quality-of-service policy to be applied to the packet flow based on the at least one characteristic associated with the packet flow, and the determined quality-of-service policy is signaled to RAN 110.

In either case, RAN 110 knows which quality-of-service policy to apply to the packet flow.

In such embodiments, for example, the characteristic associated with the packet flow and, optionally, the quality-of-service policy to be applied to the packet flow, may be determined by one or more of HA 124, PDSN 122, and the like.

For purposes of clarity, since there are many implementation options with respect to determining the characteristic(s) associated with the packet flow and determining the quality-of-service policy to be applied to the packet flow, it may be stated that information indicative of the quality-of-service policy to be applied to the packet flow based on the characteristic(s) of the packet flow may be signaled to one or more elements of RAN 110 responsible for applying the quality-of-service policy (i.e., signaling either the determined characteristic(s) and/or the quality-of-service policy to be applied).

In one embodiment, for example, both the characteristic(s) associated with the packet flow and the quality-of-service policy to be applied to the packet flow based on the characteristic(s) of the packet flow are determined by HA 124. The quality-of-service policy to be applied to the packet flow based on the characteristic of the packet flow may be determined locally (e.g., using one or more quality-of-service policy information tables available on HA 124) and/or remotely (e.g., by querying one or more other network elements using the determined characteristic of the packet flow in order to determine the quality-of-service policy to be applied to the packet flow).

In this embodiment, HA 124 signals an indication of the quality-of-service policy to be applied to the packet flow to RAN 110. The HA 124 may signal the indication of the quality-of-service policy to RAN 110 in a number of ways.

In one embodiment, for example, in which packets are tunneled from HA 124 to PDSN 122 for delivery to RAN 110 (and, thus, each tunneled packet includes an inner header and an outer header), HA 124 marks one or more fields within the inner header of each packet of the tunneled packet flow in a manner for indicating which quality-of-service policy is to be applied to the packet flow by RAN 110. The indication of which quality-of-service policy is to be applied to the packet flow by RAN 110 is marked in the inner headers because the outer headers of the tunneled packets are merely used to tunnel the packets from HA 124 to PDSN 122.

For example, the quality-of-service policy information may be marked in the inner header of each packet of the packet flow using one or more options fields, one or more existing header fields, and the like, as well as various combinations thereof. For example, the existing header fields may include one or more of the Type of Service (TOS) field (e.g., using Differentiated Services Code Point (DSCP)), one or more unused/reserved header fields, and the like, as well as various combinations thereof.

In this embodiment, PDSN 122 receives the tunneled packets of the packet flow from HA 124. The PDSN 122 strips off the outer header of each tunneled packet of the packet flow. The PDSN 122 determines the quality-of-service policy information from the inner header of each packet. The PDSN 122 then provides the packets of the packet flow to RAN 110 in a manner for informing one or more network elements of RAN 110 of the quality-of-service policy that is to be applied to the packet flow within RAN 110.

In one such embodiment, for example, in which packets are tunneled from PDSN 122 to RNC 116, PDSN 122 maps the value of the quality-of-service policy information determined from the inner header into one or more corresponding header extensions used for tunneling the packets from PDSN 122 to RNC 116 (e.g., where Generic Routing Encapsulation (GRE) tunneling is used, using one or more GRE header extensions). The PDSN 122 tunnels the packets of the packet flow into RAN 110 such that the GRE header extension(s) of each packet of the packet flow propagates an indication of the quality-of-service policy that is to be applied to the packet flow into RAN 110. In this manner, PDSN 122 marks the packets of the packet flow in a manner that enables elements of RAN 110 to determine, from the tunnel (e.g., from the GRE header extensions of the GRE tunnel), the quality-of-service policy that is to be applied to the packet flow. As such, elements of RAN 110 (e.g., RNC 116 and BTS 112) can determine the quality-of-service policy that is to be applied to the packet flow without having to inspect the IP packets transported within the GRE tunnel (which is important because the elements of RAN 110 do not have direct access to the IP packets transported within the GRE tunnel).

In another such embodiment, for example, PDSN 122 maps the value of the quality-of-service policy information determined from the inner header into one or more existing header fields. For example, PDSN 122 may map the value of the quality-of-service policy information determined from the inner header into the TOS field, one or more unused/reserved header fields, and the like, as well as various combinations thereof.

Although primarily depicted and described with respect to different methods by which HA 124 signals an indication of the quality-of-service policy to be applied to the packet flow to RAN 110, HA 124 may signal an indication of the quality-of-service policy to be applied to the packet flow to RAN 110 in any other manner by which such an indication may be provided. Similarly, although primarily depicted and described with respect to different methods by which PDSN 122 signals an indication of the quality-of-service policy to be applied to the packet flow to RAN 110, PDSN 122 may signal an indication of the quality-of-service policy to be applied to the packet flow to RAN 110 in any other manner by which such an indication may be provided.

In one embodiment, the characteristic(s) associated with a packet flow is determined inside RAN 110 and, thus, the quality-of-service policy that is to be applied to the packet flow is also determined inside RAN 110. In this embodiment, the determined characteristic(s) may or may not be signaled within RAN 110, depending on the manner in which the characteristic(s) of the packet flow is determined and/or the manner in which quality-of-service control is applied to the packet flow based on the determined characteristic(s) of the packet flow.

In one embodiment, for example, both the characteristic(s) associated with the packet flow and the quality-of-service policy to be applied to the packet flow based on the characteristic of the packet flow are determined by router 114. The quality-of-service policy to be applied to the packet flow based on the characteristic(s) of the packet flow may be determined locally (e.g., using one or more quality-of-service policy information tables available on router 114) and/or remotely (e.g., by querying one or more other network elements using the determined characteristic(s) of the packet flow in order to determine the quality-of-service policy to be applied to the packet flow).

In this embodiment, router 114 signals an indication of the quality-of-service policy to be applied to the packet flow to one or more network elements within RAN 110 (i.e., to one or more network elements within RAN 110 that apply the quality-of-service policy to the traffic flow, such as RNC 116 and BTS 112). The router 114 may signal the indication of the quality-of-service policy to be applied to the packet flow in any manner (e.g., using one or more GRE header extensions, using DSCP marking, using an existing signaling framework of RAN 110, and the like).

In another embodiment, for example, the characteristic(s) associated with the packet flow is determined by router 114 and the quality-of-service policy to be applied to the packet flow based on the characteristic(s) of the packet flow is determined by one or more other network elements within RAN 110 (i.e., network element(s) within RAN 110 that apply the quality-of-service policy to the traffic flow, such as RNC 116 and BTS 112). In this embodiment, router 114 signals an indication of the quality-of-service policy to be applied to the packet flow (by signaling an indication of the determined characteristic(s)) to the network element(s) within RAN 110 that apply the quality-of-service policy to the traffic flow.

In one embodiment, the characteristic(s) associated with a packet flow is determined outside RAN 110 and the quality-of-service policy that is to be applied to the packet flow is determined inside RAN 110. In this embodiment, an indication of the characteristic(s) associated with the packet flow is signaled to RAN 110, and RAN 110 uses the indication of the characteristic(s) associated with the packet flow to determine the quality-of-service policy that is to be applied to the packet flow. In one such embodiment, for example, HA 124 may determine the characteristic(s) associated with a packet flow and signal an indication of the characteristic(s) associated with a packet flow to router 114 for use by router 114 to determine the quality-of-service policy that is to be applied to the packet flow.

In such embodiments, one or more network elements is provisioned with quality-of-service policy information adapted to enable a determination of a quality-of-service policy to be applied to a packet flow based on one or more characteristics of the packet flow.

In one embodiment, for example, one or more network elements may be provisioned with a quality-of-service policy lookup table including quality-of-service policy information by which a quality-of-service policy to be applied to a packet flow is determined by one or more characteristics associated with the packet flow. In one such embodiment, the characteristic(s) of the packet flow may be used as a key into the quality-of-service policy lookup table. For example, the table may include a characteristic(s) field and an associated quality-of-service policy field such that the characteristic(s) of a packet flow may be used to determine the quality-of-service policy to be applied for the packet flow. The quality-of-service information may be maintained in various other ways (e.g., using different numbers/types of fields within a table, using a different number of tables, using means other than tables, and the like, as well as various combinations thereof).

The quality-of-service policy provisioned for a given characteristic or set of characteristics may be determined in any manner. The quality-of-service policy may be derived from any source. For example, the quality-of-service policy applied for a given characteristic(s) of a packet flow may be based on one or more of business agreements, service level agreements, and the like, which may be established between different providers (e.g., between content providers and service providers, between service providers and network providers, and the like). For example, the quality-of-service policy applied for a given characteristic(s) of a packet flow may be based on service contracts between providers and subscribers (e.g., where a subscriber may subscribe to a higher level of service for a larger fee). The quality-of-service policy applied for a given characteristic(s) of a packet flow may be derived from any other source of such information.

The quality-of-service policy information may be provisioned in the network in any manner. The quality-of-service policy information may be provisioned periodically and/or aperiodically. The quality-of-service policy information may be provisioned automatically (e.g., using configuration files automatically downloaded to HA 124, router 114, and the like) and/or manually (e.g., by one or more network administrators using one or more management systems). The quality-of-service policy information also may be updated in the network in any manner. The quality-of-service policy information may be updated for any reason. The quality-of-service policy information may be provisioned and/or updated in the network in any other manner, as long as the quality-of-service policy information is available for use in determining which quality-of-service policy to apply to a particular packet flow.

The quality-of-service policy information for a quality-of-service policy may include any information adapted to enable application of the quality-of-service policy to packet flows determined to have the particular characteristic(s) for the quality-of-service policy.

In one embodiment, for example, quality-of-service policy information for a quality-of-service policy may include a value indicative of a priority level to be supported for packet flows having the associated characteristic(s). In another embodiment, for example, quality-of-service policy information for a quality-of-service policy may include multiple quality-of-service parameters (e.g., a priority level, a bandwidth requirement, a data rate requirement, an air interface scheduling weight, and the like) to be applied to packet flows having the associated characteristic(s). The quality-of-service policy information for a quality-of-service policy may include any other information.

In such embodiments, network element(s) of RAN 110 responsible for applying the quality-of-service policy (e.g., RNC 116 and/or BTS 112) will receive information indicative of the level of quality which should be applied to a packet flow based on one or more characteristics of the packet flow.

In such embodiments, any numbers and/or types of quality-of-service policies may be supported.

In one embodiment, the supported quality-of-service policies provide quality-of-service differentiation within a Best Effort (BE) service class. In one such embodiment, quality-of-service differentiation is provided within the BE service class by supporting multiple different quality-of-service levels within the BE service class. In this manner, within a RAN, non-QoS-aware applications that are sensitive to QoS metrics (e.g., packetized voice, streaming video, and the like) may be prioritized over applications that are not sensitive to QoS metrics (e.g., such as FTP downloads, e-mail delivery, and the like).

As an example, consider an embodiment in which three quality-of-service policies (in this example, priority levels) are supported within the BE service class (e.g., high priority, medium priority, and low priority).

In this example, a determination that a packet flow is originating from a Verizon Wireless VCAST server may result in application of the high priority service class (e.g., where Verizon has a service level agreement with the network provider to receive high priority treatment for video streamed from its servers over RAN 110).

In this example, a determination that a packet flow is providing streaming video from YouTube may result in application of the low priority service class (e.g., where YouTube has not entered into any agreement with the network provider to receive any priority treatment for videos streamed from its servers over RAN 110).

In this example, a determination that a packet flow is providing packetized voice for an voice session supported by Skype may result in application of the medium priority service class (e.g., where Skype has a service level agreement with the network provider to receive medium priority treatment for voice sessions over RAN 110, but is not willing to pay a higher premium for high priority treatment).

In such embodiments, an indication of the quality-of-service policy that is to be applied to the packet flow is ultimately received within RAN 110 for use by one or more elements of RAN 110 to apply the quality-of-service policy to the packet flow within RAN 110. In one embodiment, for example, the quality-of-service control is applied at one or both of the RNC 116 and the BTS 112.

In such embodiments, irrespective of whether the quality-of-service policy to be applied to a packet flow is determined outside RAN 110 or inside RAN 110, RNC 116 receives signaling indicative of the quality-of-service policy to be applied to the packet flow (e.g., signaling initiated by HA 124 or router 114). The RNC 116 determines the quality-of-service policy to be applied to the packet flow based on the received signaling. For example, RNC 116 may determine the quality-of-service policy to be applied for a packet flow based on GRE header extensions associated with the packets of the packet flow, DSCP markings in packets of the packet flow, and the like.

The RNC 116, upon determining the quality-of-service policy to be applied to the packet flow, applies quality-of-service control to the packet flow and/or signals BTS 112 with an indication of the quality-of-service policy to be applied to the packet flow.

In one embodiment, in which RNC 116 applies quality-of-service control for the packet flow, RNC 116 applies a bandwidth filter to the packet flow in order to police the packet flow according to the associated quality-of-service policy. In one such embodiment, for example, RNC 116 may increase a bandwidth cap for the packet flow so that throughput for the packet flow may be increased. The RNC 116 may apply any other quality-of-service control functions which may be applied within a RAN.

In one embodiment, in which RNC 116 signals BTS 112 with an indication of the quality-of-service policy to be applied to the packet flow, RNC 116 may signal BTS 112 with an indication of the quality-of-service policy to be applied to the packet flow in any manner. In one such embodiment, RNC 116 implicitly signals BTS 112 using the packets of the packet flow (e.g., the markings indicative of the quality-of-service policy to be applied to the packet flow remain in the packets of the packet flow which are propagated to BTS 112 via router 114). In another such embodiment, RNC 116 explicitly signals BTS 112 with an indication of the quality-of-service policy to be applied to the packet flow (e.g., using an existing signaling framework of RAN 110).

In one embodiment, in which BTS 112 applies quality-of-service control for the packet flow, BTS 112, upon determining the quality-of-service policy to be applied to the packet flow, applies quality-of-service control to the packet flow.

In one embodiment, in which BTS 112 applies quality-of-service control for the packet flow, BTS 112 applies a scheduling weight to the packet flow according to the associated quality-of-service policy for scheduling use of the resources of the air interface between BTS 112 and MN 102 for which the packet flow is intended. For example, in an EVDO-based RAN, BTS 112 adjusts the Grade of Service (GoS) for the packet flow. The BTS 112 may apply any other quality-of-service control functions which may be applied over the air interface of a RAN.

In one embodiment, one or more of the characteristics associated with a packet flow may be determined from a source other than information included in the packets of the packet flow. In one embodiment, for example, one or more of the characteristics associated with a packet flow may be determined from one or more profiles associated with the packet flow (e.g., using a subscriber profile associated with the subscriber for which the packet flow is intended, using a terminal profile associated with the terminal being used by the subscriber to receive the packet flow, and the like, as well as various combinations thereof).

The profile associated with the packet flow may be provided in any manner.

In one embodiment, for example, the profile associated with the packet flow may be provided from within RAN 110 for use by RAN 110 in applying a quality-of-service policy to the packet flow within RAN 110. For example, a profile associated with the packet flow may be propagated from a server within RAN 110 (not depicted) to RNC 116 of RAN 110.

In one embodiment, for example, the profile associated with the packet flow may be provided from outside RAN 110 for use by RAN 110 in applying a quality-of-service policy to the packet flow within RAN 110. For example, a profile associated with the packet flow may be propagated from AAA 121 of CN to RNC 116 of RAN 110 via PDSN 122 and router 114.

The profile used to determine the quality-of-service policy to be applied for a packet flow may include subscriber-specific information associated with the subscriber that is using MN 102 and/or terminal-specific information associated with MN 102.

The subscriber-specific information may include a priority level subscribed to by the subscriber, different priority levels subscribed to by the subscriber for different applications, and the like, as well as various combinations thereof.

The terminal-specific information may include the type of the terminal (e.g., cell phone, PDA, laptop, and the like), a list of decoders supported by the terminal, a screen size available at the terminal, and the like, as well as various combinations thereof.

The profile may include any other information.

In one embodiment, multiple profiles may be used.

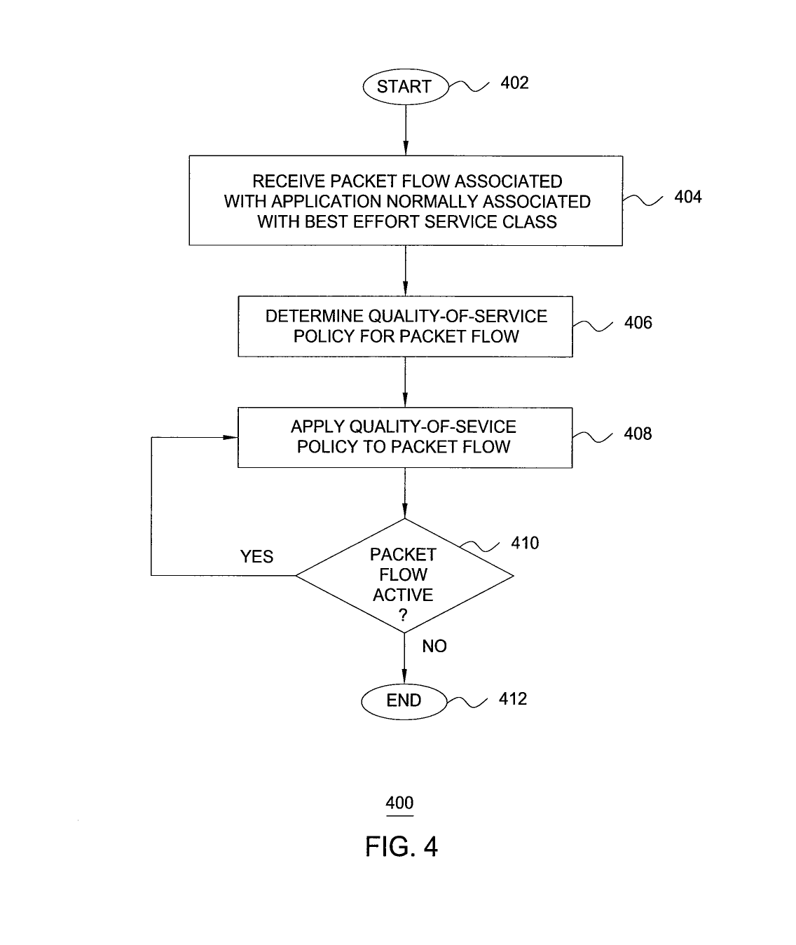

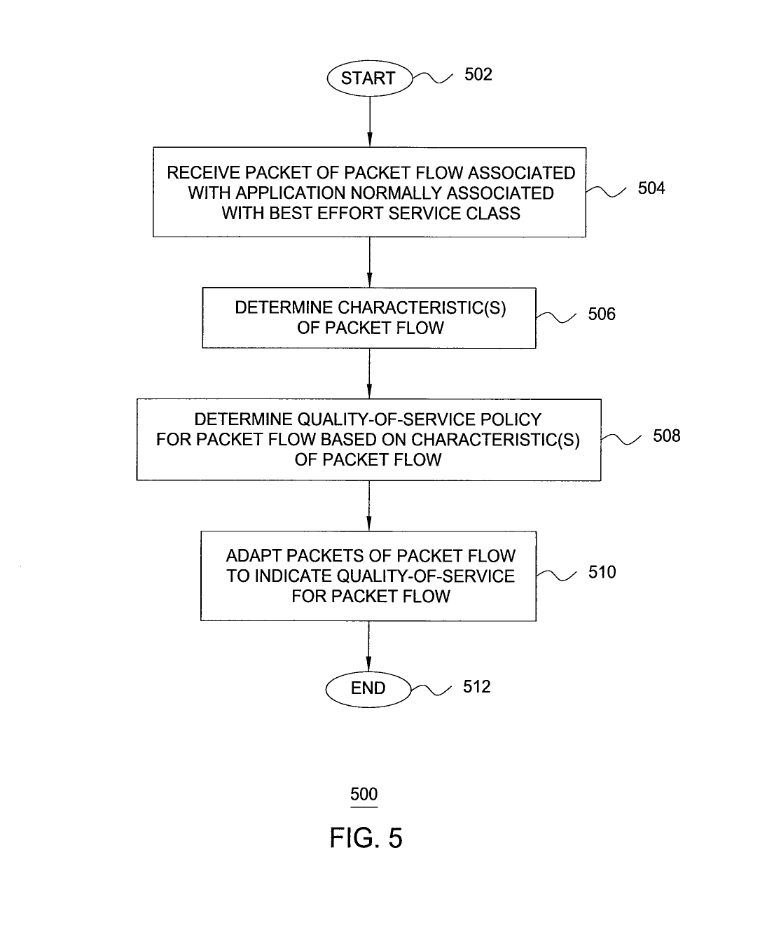

As described herein with respect to FIG. 2, the Detection Function and the RAN Priority Function may be implemented in many ways (e.g., by any combination of network elements inside and outside the RAN, using any manner of signaling quality-of-service policy indicators, and the like). As such, for purposes of clarity in capturing the flexibility of the quality-of-service control functions described herein, a generic flow diagram illustrating the Detection Function and the RAN Priority Function is depicted and described herein with respect to FIG. 3, FIG. 4, and FIG. 5.

FIG. 3 depicts a method according to one embodiment of the present invention. Specifically, method 300 of FIG. 3 includes a method for providing quality-of-service control for a packet flow within a RAN. Although depicted and described as being performed serially, at least a portion of the steps of method 300 may be performed contemporaneously, or in a different order than depicted and described with respect to FIG. 3. The method 300 begins at step 302 and proceeds to step 304.

At step 304, a Detection Function is applied. The Detection Function is applied to determine at least one characteristic of the packet flow and to determine a quality-of-service policy to be applied for the packet flow within the RAN. The Detection Function may be applied inside the RAN and/or outside the RAN. At step 306, a RAN Priority Function is applied. The RAN Priority Function is applied to enable differentiated quality-of-service within the RAN for the packet flow. At step 308, method 300 ends.

FIG. 4 depicts a method according to one embodiment of the present invention. Specifically, method 400 of FIG. 4 includes a method for providing quality-of-service control for a packet flow within a RAN. Although depicted and described as being performed serially, at least a portion of the steps of method 400 may be performed contemporaneously, or in a different order than depicted and described with respect to FIG. 4. The method 400 begins at step 402 and proceeds to step 404.

At step 404, a packet flow is received. The packet flow is associated with an application that is normally associated with a best effort service class within the RAN.

At step 406, a quality-of-service policy to be applied for the packet flow is determined. The quality-of-service policy to be applied for the packet flow may be determined from information included in the packets of the packet flow and/or from information not included in the packets of the packet flow.

At step 408, the quality-of-service policy is applied to the packet flow within the RAN. The quality-of-service policy may be applied on one or more network elements within the RAN adapted for applying the quality-of-service policy within the RAN.

At step 410, a determination is made as to whether the packet flow is active. If the packet flow is active, method 400 returns to step 408 such that the quality-of-service policy continues to be applied to the packet flow within the RAN. If the packet flow is not active, method 400 proceeds to step 412, where method 400 ends.

FIG. 5 depicts a method according to one embodiment of the present invention. Specifically, method 500 of FIG. 5 includes a method for providing quality-of-service control for a packet flow within a RAN. Although depicted and described as being performed serially, at least a portion of the steps of method 500 may be performed contemporaneously, or in a different order than depicted and described with respect to FIG. 5. The method 500 begins at step 502 and proceeds to step 504.

At step 504, packets of the packet flow are received. The packet flow is associated with an application that is normally associated with a best effort service class within the RAN. At step 506, at least one characteristic of a packet flow is determined. At step 508, a quality-of-service policy to be applied to the packet flow is determined based on the at least one characteristic of the packet flow. At step 510, the packets of the packet flow are adapted to indicate the quality-of-service policy to be applied to the packet flow within the RAN.

At step 512, method 500 ends. Although depicted and described as ending, the packets of the packet flow are then propagated either (1) from outside the RAN toward the RAN for delivery to one or more network elements within the RAN adapted for applying the quality-of-service policy within the RAN or (2) within the RAN for delivery to one or more network elements within the RAN adapted for applying the quality-of-service policy within the RAN.

The operation of methods 300, 400, and 500 may be better understood by way of reference to FIG. 2.

Although primarily depicted and described herein with respect to a specific configuration of the RAN, the quality-of-service control functions depicted and described herein may be supported for other configurations of the RAN.

For example, although primarily depicted and described with respect to embodiments in which one router (i.e., router 114) supports communications between RNC 116 and BTS 112 and supports communications between CN 120 and RAN 120, one or more additional routers may be employed in order to support communications between RNC 116 and BTS 112 and/or to support communications between CN 110 and RAN 120. Thus, although primarily depicted and described herein with respect to embodiments in which bearer traffic always traverses the same router, bearer traffic between RNC 116 and BTS 112 may be routed using any number and/or configuration of routing elements.

Although primarily depicted and described herein with respect to providing quality-of-service differentiation in an EVDO-based RAN, the quality-of-service control functions depicted and described herein may be utilized for providing quality-of-service differentiation in other types of RANs. For example, the quality-of-service control functions depicted and described herein may be utilized for providing quality-of-service differentiation in other types of Code Division Multiple Access (CDMA) RANs, in Universal Mobile for Telecommunications (UMTS) RANs, in Worldwide Interoperability for Microwave Access (WiMAX) RANs, and the like.

In a UMTS-based RAN, functions described herein as being performed by RNC 116 may be performed by a Radio Network Controller and functions described herein as being performed by BTS 112 may be performed by a NodeB. Similarly, in a WiMAX network, functions described herein as being performed by RNC 116 may be performed by an Access Service Network-Gateway (ASN-GW) and functions described herein as being performed by BTS 112 may be performed by a base station. Thus, RNC 116 and BTS 112 may be referred to more generically as a controller and a radio access node, respectively.

Although primarily depicted and described herein with respect to IP packets, the quality-of-service control functions depicted and described herein may be utilized for controlling quality-of-service in RANs that convey information using other types of packets. In such embodiments, quality-of-service policy indicators may be marked in the packets in any manner supported by the type of packet for which quality-of-service policy indicators must be marked.

Although primarily depicted and described herein with respect to specific types of tunneling (e.g., IP-based tunneling between HA 124 and PDSN 122, and GRE-based tunneling between PDSN 122 and RNC 116), the quality-of-service control functions depicted and described herein may be utilized for controlling quality-of-service in networks that convey information using other types of tunneling. In such embodiments, quality-of-service policy indicators may be marked in the packets in any manner supported by the type of tunneling for which quality-of-service policy indicators must be marked.

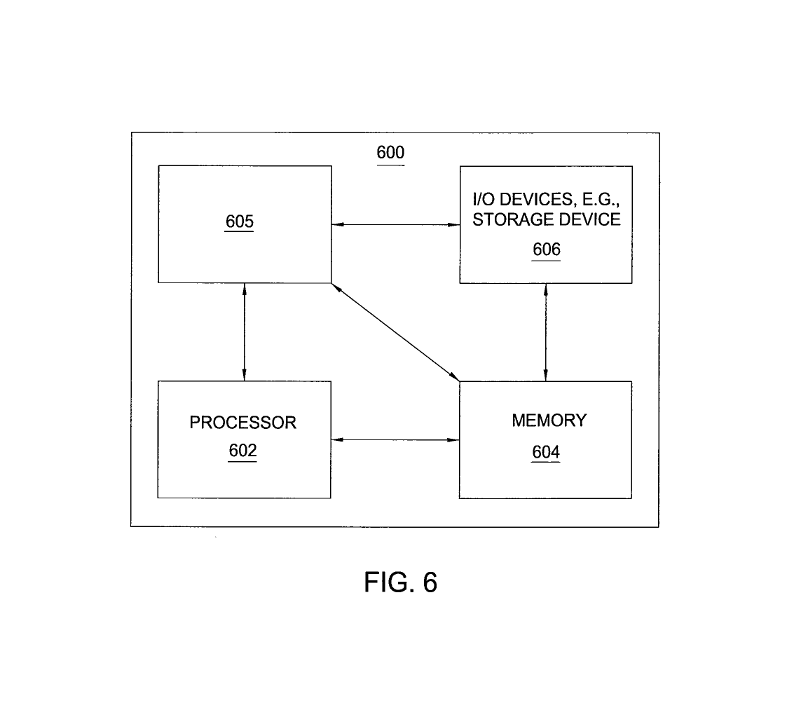

FIG. 6 depicts a high-level block diagram of a general-purpose computer suitable for use in performing the functions described herein. As depicted in FIG. 6, system 600 comprises a processor element 602 (e.g., a CPU), a memory 604, e.g., random access memory (RAM) and/or read only memory (ROM), a quality-of-service control module 605, and various input/output devices 606 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the quality-of-service control process 605 can be loaded into memory 604 and executed by processor 602 to implement the functions as discussed above. As such, quality-of-service control process 605 (including associated data structures) of the present invention can be stored on a computer readable medium or carrier, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method for providing quality-of-service in a radio access network (RAN), comprising:
receiving packets of a packet flow at a first network element of the RAN, wherein the packet flow is associated with an application normally served in a best effort service class of the RAN, wherein each packet of the packet flow comprises an indication of a quality-of-service policy to be applied to the packet flow within the RAN, wherein the quality-of-service policy to be applied to the packet flow within the RAN is based on at least one characteristic of the packet flow; and
applying the indicated quality-of-service policy to the packet flow within the RAN.

2. The method of claim 1, wherein the at least one characteristic of the packet flow comprises at least one of an application associated with the packet flow, a source of the packet flow, a destination of the packet flow, a provider associated with the packet flow, and a subscriber associated with the packet flow.

3. The method of claim 1, wherein, for each packet of the packet flow, the indication of the quality-of-service policy to be applied to the packet flow is provided using at least one marking associated with the packet.

4. The method of claim 1, wherein, for each packet of the packet flow, the indication of the quality-of-service policy to be applied to the packet flow is conveyed using one of at least one header extension and at least one header field.

5. The method of claim 4, wherein the at least one header extension comprises at least one Generic Routing Encapsulation (GRE) header extension, wherein the at least one header field comprises at least one of a Differentiated Services Code Point (DSCP) field and at least one unused header field.

6. The method of claim 1, wherein, for each packet of the packet flow, the indication of the quality-of-service policy to be applied to the packet flow is set inside the RAN.

7. The method of claim 1, wherein, for each packet of the packet flow, the indication of the quality-of-service policy to be applied to the packet flow is set outside the RAN.

8. The method of claim 7, wherein, for each packet of the packet flow, the indication of the quality-of-service policy to be applied to the packet flow is set by a first network element disposed within a core network.

9. The method of claim 8, wherein, for each packet of the packet flow, the indication of the quality-of-service policy to be applied to the packet flow is set using at least one header extension applied to the packet.

10. The method of claim 8, wherein the first network element is adapted to, for each packet of the packet flow, perform the following:
receive the packet from a second network element disposed within the core network, wherein the received packet comprises an outer header and an inner header;
remove the outer header of the packet;
determine, from the inner header of the packet, a value indicative of the quality-of-service policy to be applied to the packet flow; and
forming a modified packet using the inner packet and the value indicative of the quality-of-service policy to be applied to the packet flow; and
propagating the modified packet toward the RAN.

11. The method of claim 10, wherein the value indicative of the quality-of-service policy to be applied to the packet flow is determined from at least one of a Type of Service (ToS) field, at least one options field, and at least one unused header field

12. The method of claim 10, wherein forming the modified packet comprises at least one of adding at least one header extension to the inner packet and setting at least one value in at least one header field of the inner packet.

13. The method of claim 1, wherein the first network element of the RAN comprises one of a controller and a radio access node.

14. The method of claim 1, wherein the first network element of the RAN comprises a controller, wherein applying the indicated quality-of-service policy to the packet flow comprises:
applying flow control to the packet flow at the first network element of the RAN.

15. The method of claim 1, wherein the first network element of the RAN comprises a radio access node, wherein applying the indicated quality-of-service policy to the packet flow comprises:
scheduling transmission of the packets of the packet flow over an air interface based on the indicated quality-of-service policy.

16. The method of claim 1, wherein applying the indicated quality-of-service policy to the packet flow within the RAN comprises:
applying the indicated quality-of-service policy to the packet flow at the first network element of the RAN.

17. The method of claim 16, further comprising:
propagating the packets of the packet flow toward a second network element of the RAN.

18. The method of claim 17, wherein the packets propagated toward the second network element of the RAN include the indication of the quality-of-service policy to be applied to the packet flow within the RAN.

19. The method of claim 17, further comprising:
receiving the packets of the packet flow at the second network element of the RAN; and
applying the indicated quality-of-service policy to the packet flow at the second network element of the RAN.

20. The method of claim 19, wherein applying the indicated quality-of-service policy to the packet flow at the second network element of the RAN comprises:
scheduling transmission of the packets of the packet flow over an air interface based on the indicated quality-of-service policy.

21. The method of claim 1, wherein the at least one characteristic of the packet flow is determined using at least one of information included at least one header of at least one packet of the packet flow and a deep packet inspection function.

22. The method of claim 1, wherein the at least one characteristic of the packet flow is determined at least one of inside the RAN and outside the RAN.

23. An apparatus for providing quality-of-service in a radio access network (RAN), comprising:
means for receiving packets of a packet flow at a first network element of the RAN, wherein the packet flow is associated with an application normally served in a best effort service class of the RAN, wherein each packet of the packet flow comprises an indication of a quality-of-service policy to be applied to the packet flow within the RAN, wherein the quality-of-service policy to be applied to the packet flow within the RAN is based on at least one characteristic of the packet flow; and
means for applying the indicated quality-of-service policy to the packet flow within the RAN.

24. A method for providing quality-of-service in a radio access network (RAN), comprising:
receiving packets of a packet flow, wherein the packet flow is associated with an application normally served in a best effort service class of the RAN;
determining a quality-of-service policy to be applied to the packet flow within the RAN, wherein the quality-of-service policy is based on at least one characteristic associated with the packet flow; and
applying the indicated quality-of-service policy to the packet flow within the RAN.

25. The method of claim 24, wherein the indication of the quality-of-service policy to be applied to the packet flow within the RAN is determined using information included within each of the packets of the packet flow.

26. The method of claim 24, wherein the indication of the quality-of-service policy to be applied to the packet flow within the RAN is determined using at least one profile.

27. The method of claim 26, wherein the at least one profile is received from at least one network element outside of the RAN.

28. The method of claim 26, wherein the at least one profile comprises at least one of a subscriber profile and a terminal profile.

29. An apparatus for providing quality-of-service in a radio access network (RAN), comprising:
means for receiving packets of a packet flow, wherein the packet flow is associated with an application normally served in a best effort service class of the RAN;
means for determining a quality-of-service policy to be applied to the packet flow within the RAN, wherein the quality-of-service policy is based on at least one characteristic associated with the packet flow; and
means for applying the indicated quality-of-service policy to the packet flow within the RAN.
